(19) United States
(12) Patent Application Publication
(10) Pub. No.: US 2012/0118939 A1
(43) Pub. Date: May 17, 2012

(54) PROCESS AND APPARATUS FOR MANUFACTURING SEMICONDUCTOR DEVICE

(75) Inventors: Keiyo KUSANAGI, Tokyo (JP); Koichi HATAKEYAMA, Tokyo (JP); Mitsuhisa WATANABE, Tokyo (JP); Yusuke NAKANOYA, Tokyo (JP); Hidenori MATSUSHITA, Tokyo (JP); Toru MEURA, Tokyo (JP); Kenzou MAEJIMA, Tokyo (JP); Hiroki NIKAIDO, Tokyo (JP); Mina NIKAIDO, Tokyo (JP)

(73) Assignees: SUMITOMO BAKELITE CO., LTD., Tokyo (JP); ELPIDA MEMORY, INC., Tokyo (JP)

(21) Appl. No.: 13/295,581

(22) Filed: Nov. 14, 2011

(30) Foreign Application Priority Data
Nov. 15, 2010 (JP) 2010-254535

(51) Int. Cl. B23K 1/008; B23K 31/02

(52) U.S. Cl. 228/180.22; 228/19

(57) ABSTRACT

The process for manufacturing the semiconductor device and the apparatus, which achieve stable production of semiconductor devices with improved connection reliability, is presented. First terminals of circuit boards 1 are arranged to face the corresponding bumps of semiconductor chips 2, respectively, and the resin layer 3 is disposed between the respective first terminals and the respective bumps to form laminates, and the laminates are simultaneously compressed from a direction of lamination, while heating a plurality of laminates. In such case, the diaphragm 54 disposed in a heating furnace 51 is abutted against a plurality of laminates or a member 531 to elastically deform the members while a plurality of laminates is heated in the heating furnace 51, so that laminates are simultaneously compressed from a direction of lamination, while heating thereof in a vacuum.

This application is based on Japanese patent application No. 2010-254,535, the content of which is incorporated hereinto by reference.

### BACKGROUND

1. Technical Field

The present invention relates to a process and an apparatus for manufacturing a semiconductor device.

2. Background Art

A production of a semiconductor device involves, for example, conducting a process for bonding a terminal of a semiconductor element and a terminal of a substrate with solder.

Since a gap is formed between the semiconductor element and the substrates after bonding with solder, it is necessary to fill such gap with a cured product of a resin.

In the conventional process, after the junction is formed with solder, a flowable thermosetting resin flows into the gap between the semiconductor element and the substrate or the like. Then, the resin is cured to fill the gap between the semiconductor element and the substrate. However, since it is difficult to completely flow the flowable thermosetting resin into the aforementioned gap in the above-described method, an alternative method described below has been proposed in Japanese Patent Laid-Open No. 2004-311,709.

Japanese Patent Laid-Open No. 2004-311,709 discloses a method and an apparatus, in which an underfill resin having a form of a film is disposed on a surface of a substrate, and then a semiconductor element is installed on the underfill resin. In the method of the Japanese Patent Laid-Open No. 2004-311,709, the semiconductor element is pressed against the substrate after the semiconductor element is installed on the underfill resin, and the underfill resin is cured in a high pressure atmosphere after a laminate of the semiconductor element and the substrate is formed.

It is found that, while demands for the semiconductor devices having improved connection reliability between the substrate and the semiconductor element are increased in recent years, it is difficult to satisfy such demands with the above described manufacturing method.

Since demands for mass production of semiconductor device are increased in recent years, in addition to the above-described demands, the inventors of the present application developed the following approach, in consideration of the mass production of the semiconductor devices. First of all, a plurality of substrates, each of which is provided with a layer of a thermosetting resin, are disposed on a hot platen. Then, semiconductor elements are disposed on the thermosetting resin layer.

In this process, a load is applied to the semiconductor element disposed on the thermosetting resin layer to press the element against the substrate, so that a terminal of the semiconductor element extends through the thermosetting resin layer so as to be in contact with a terminal of the substrate to form a laminate. This operation is repeated to obtain a plurality of laminates. Then, the terminals of the semiconductor elements in the laminate are joined with the terminals of the substrates, and the resin layer is compressed and cured.

However, since the thermosetting resin layer is in the condition of being heated by the hot platen in this method, unwanted cure may be gradually progressed. While the substrate of a first laminate is pressed against the corresponding semiconductor chip, the cure of a thermosetting resin layer on a substrate other than the first substrate may proceed.

Accordingly, the force for pressing against the first one of the substrates and the semiconductor chips is considerably different from the force for pressing against the last one of the substrates and the semiconductor chips.

It is concerned that this causes a defect of an electric conduction between the terminal provided in the substrate and the terminal provided in the semiconductor chip to deteriorate the connection reliability.

### SUMMARY

According to one aspect of the present invention, there is provided a process for manufacturing a semiconductor device, the semiconductor device comprising a circuit board including a first terminal, which has a solder layer on a surface thereof; and a semiconductor chip including a bump, which is joined to the first terminal of the circuit board, the process comprising the steps of:

obtaining a laminate by disposing a resin layer containing a flux activator compound and a thermosetting resin between the first terminal of the circuit board and the bump of the semiconductor chip; and

heating the laminate at a temperature that is equal to or higher than a melting point of the solder layer of the first terminal to create a solder joint of the first terminal with the bump, while compressing the laminate with a fluid, thereby curing the resin layer,

wherein, in the step of obtaining the laminate,

the first terminals of a plurality of the circuit boards are arranged to face the corresponding bumps of a plurality of the semiconductor chips,

the resin layer is disposed between the respective first terminals and the respective bumps to form a plurality of laminates, and

the plurality of laminates are simultaneously compressed from a direction of lamination of the laminate under a vacuum condition by causing an elastic deformation of a diaphragm disposed in a heating furnace while heating a plurality of the laminates in the heating furnace.

According to the above-described aspect of the present invention, a plurality of laminates are heated and compressed under the vacuum condition, so that air bubbles present in the resin layer of the laminate, air bubbles in the interface between the resin layer and the semiconductor chip, and air bubbles in the interface between the resin layer and the circuit board can be removed.

This allows providing enhanced connection reliability between the bump of the semiconductor chip and the first terminal of the circuit board.

Further, the diaphragm is elastically deformed to compress the plurality of laminates, so that the laminates can be firmly compressed to provide enhanced connection reliability between the bump of the semiconductor chip and the first terminal of the circuit board.

Further, the above-described aspect of the present invention involves that a plurality of laminates are compressively clamped from a direction of lamination of the laminate at the same time, while heating the plurality of laminates. This allows preventing unwanted progress of the cure of the thermosetting resin composing the other laminates during compressively clamping the circuit board of the first one of the laminates and the corresponding semiconductor chip while heating thereof. Therefore, the stable production of semiconductor devices with improved connection reliability can be achieved.

Further, according to the present invention, an apparatus, which can be employed for a process for manufacturing the semiconductor device as described above can also be provided.

More specifically, according to another aspect of the present invention, there is provided an apparatus to contact a first terminal having a solder layer on a surface thereon in a circuit board and a bump of a semiconductor chip after depositing a resin layer containing a flux activator compound and a thermosetting resin is disposed between the first terminal of the circuit board and the bump of the semiconductor chip to form a laminate, the apparatus comprising:

a heating furnace for heating a plurality of laminates;

a unit of creating a vacuum in the heating furnace; and

an elastically deformable diaphragm, disposed in the heating furnace and capable of simultaneously compressing the laminates from a direction of lamination of the plurality of laminates.

According to the present invention, the process and the apparatus for manufacturing the semiconductor device, which achieve stable production of semiconductor devices with improved connection reliability, is presented.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 represents a schematic diagram, illustrating a process for manufacturing a semiconductor device according to an embodiment of the present invention;

FIG. 2 represents a schematic diagram, illustrating the process for manufacturing the semiconductor device;

FIG. 3 represents a schematic diagram, illustrating the process for manufacturing the semiconductor device;

FIG. 4 represents a cross-sectional view, illustrating the apparatus for manufacturing a semiconductor device;

FIG. 5 represents a cross-sectional view, illustrating the apparatus for manufacturing the semiconductor device;

FIG. 6 represents a cross-sectional view, illustrating the apparatus for manufacturing the semiconductor device;

FIG. 7 represents a cross-sectional view of laminates, illustrating a condition, in which a plurality of laminates are pinched by a jig;

FIG. 8 represents a cross-sectional view, illustrating an apparatus for manufacturing the semiconductor device;

FIG. 9 represents a schematic diagram, illustrating the process for manufacturing the semiconductor device; and

FIG. 10 represents a cross-sectional view, illustrating a modified embodiment of an apparatus for manufacturing a semiconductor device.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Preferable embodiments of the present invention will be described in reference to the annexed figures as follows.

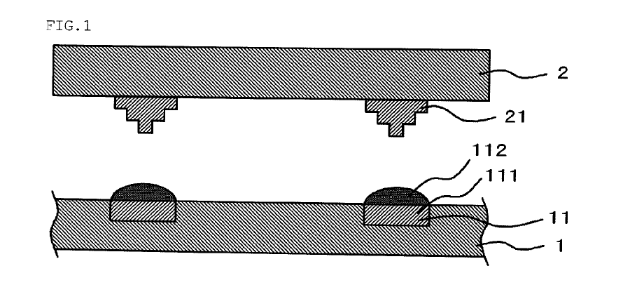

First of all, an overview of the process for manufacturing the semiconductor device of the present embodiment will be described in reference to FIGS. 1 to 6.

The process for manufacturing the semiconductor device of the present embodiment is a process for manufacturing a semiconductor device, which comprises a circuit board 1 including a first terminal 11 that has a solder layer 112 on the surface, and a semiconductor chip 2 including a bump 21 joined to the first terminal 11 of the circuit board 1.

The process for manufacturing such semiconductor device includes a step of disposing a resin layer 3 containing a flux activator compound and a thermosetting resin between the first terminal 11 of the circuit board 1 and the bump 21 of the semiconductor chip 2 to obtain a laminate 4, and a step of heating the laminate 4 to a temperature that is not lower than a melting point of the solder layer 112 of the first terminal 11 to create a solder-joint with the first terminal 11 and the bump 21 and to cure the resin layer 3 while compressing the laminate 4 by means of a fluid.

In the aforementioned step of disposing the resin layer 3 to obtain the laminate 4, the first terminals 11 of a plurality of circuit boards 1 are arranged to face the corresponding bumps 21 of a plurality of semiconductor chips 2, respectively, and the resin layer 3 is disposed between the respective first terminals 11 and the respective bumps 21 to form a plurality of laminates 4, and then the plurality of laminates 4 are simultaneously compressed from a direction of lamination of laminate 4, while heating the plurality of laminates 4. In such occasion, while the plurality of laminates 4 is heated in a heating furnace 51, the diaphragm 54 disposed in the heating furnace 51 is abutted against the plurality of laminates 4 or a member 531 for compressively clamping the plurality of laminates 4 to elastically deform the diaphragm 54, so that the plurality of laminates 4 are simultaneously compressed from a direction of lamination of the laminate 4, while heating the plurality of laminates 4 in a vacuum.

Next, the process for manufacturing the semiconductor device of the present embodiment will be described in detail.

In the beginning, as shown in FIG. 1, the circuit board 1 is prepared.

Such circuit board 1 is typically, for example, a flexible substrate, a rigid substrate, or a ceramic substrate or the like.

The circuit board 1 includes the first terminal 11, and the first terminal 11 includes a main body 111 of the first terminal and a solder layer 112 provided on a surface of the main body 111 of the first terminal.

The shape or feature of the main body 111 of the first terminal is not particularly limited, and typically includes a convex feature or a concave feature. Also, a material available for composing the main body 111 of the first terminal is not particularly limited, and typically includes gold, copper, nickel, palladium and aluminum.

A material of the solder layer 112 is not particularly limited, and typically includes an alloy containing at least two or more types of metals selected form a group consisting of tin, silver, lead, zinc, bismuth, indium and copper. Among these, an alloy containing at least two or more types of metals selected form a group consisting of tin, silver, lead, zinc and copper may be preferably employed. The melting point of the solder layer 112 is not lower than 110 degrees centigrade and not higher than 250 degrees centigrade, and preferably not lower than 140 degrees centigrade and not higher than 230 degrees centigrade.

The solder layer 112 may be composed by plating the main body 111 of the first terminal with solder, or may be a layer composed of solder bumps or the like formed by disposing solder balls or solder paste over the main body 111 of the first terminal.

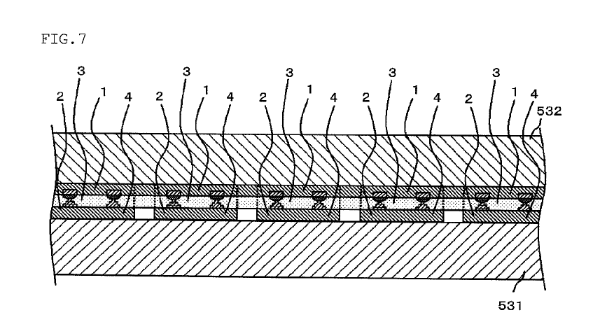

Here, as shown in FIG. 7, the plurality of circuit boards 1 are configured to be arranged and coupled side by side. For example, when the circuit board 1 is a substrate, the respective substrates are coupled to each other to compose one single larger substrate. In addition to above, as indicated by dotted line in FIG. 7, cut lines for carrying out separations into the individual circuit boards 1 are formed in the larger substrate.

Next, the semiconductor element 2 is prepared (see FIG. 1). The semiconductor element 2 has the bumps 21.

The shape or feature of the bump 21 is not particularly limited, and may be a shape that is conformable for creating solder joint with the first terminal 11, and for example, typically includes a convex feature or a concave feature. Also, the material for composing the bump 21 is not particularly limited, and typically includes gold, copper, nickel, palladium and aluminum.

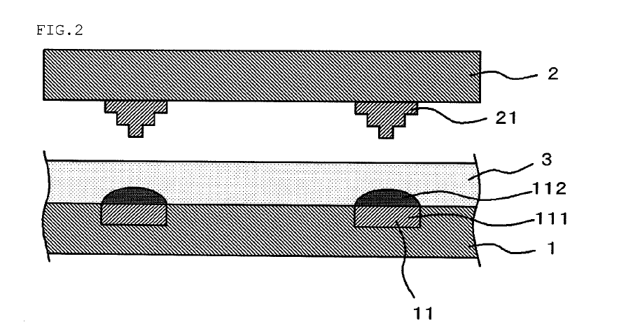

Next, as shown in FIG. 2, the resin layer 3 containing the flux activator compound and the thermosetting resin is disposed between the first terminal 11 of the circuit board 1 and the bump 21 of the semiconductor element 2, and an alignment of the first terminals 11 and the bumps 21 is conducted. In this case, the alignment of the plurality of circuit boards 1 and the plurality of semiconductor elements 2 is conducted. In this process step, the plurality of multi-layered members 4, each of which is provided with the resin layer 3 disposed between the circuit board 1 and the semiconductor element 2, is obtained. However, the bumps 21 of the semiconductor element 2 are not in the condition to be wedged in the resin layer 3 to be in contact with the first terminal 11.

The resin layer 3 is configured to contain a thermosetting resin, which is capable of fill a gap between the circuit board 1 and the semiconductor element 2.

Available thermosetting resins contained in the resin layer 3 may be, for example, epoxy resin, oxetane resin, phenolic resin, (meta) acrylate resin, unsaturated polyester resin, diallylphthalate resin, maleimide resin and the like. One of these resins may be employed alone, or a combination of two or more of these resins may be employed.

Among these, the epoxy resin is suitably used since it is excellent in curability, preservability, and heat resistance, moisture resistance, chemical resistance, or the like in a cured product.

The minimum melt viscosity at a temperature of 100 to 200 degrees centigrade of the resin layer 3 is preferably 1 to 1,000 Pa·s, and more preferably 1 to 500 Pa·s. The minimum melt viscosity at a temperature of 100 to 200 degrees centigrade of the resin layer 3 within the above-described range provides a difficulty in creating a space (void) in the cured product. The melt viscosity can be measured under a condition of, for example, applying a shear of a frequency of 1 Hz at a temperature increase rate of 10 (degrees centigrade/minute) to a film-shaped sample specimen by employing a rheometer, which serves as a device for measuring a viscoelasticity.

The resin layer 3 is a layer of a resin, which serves as removing an oxide film from the surface of the solder layer 112 in the process for creating the solder joint. Since the resin layer 3 has a flux effect, the oxide film covering the surface of the solder layer 112 can be removed, and therefore the solder joint can be created. In order to provide the flux effect to the resin layer 3, it is essential for the resin layer 3 to contain a flux activator compound. The flux activator compound contained in the resin layer 3 is not particularly limited as long as the compound is suitable for the solder joint, and compounds having any one of carboxyl group and phenolic hydroxyl group or compounds having both of carboxyl group and phenolic hydroxyl group are preferable.

The compounding ratio of the flux activator compound in the resin layer 3 may be preferably equal to or larger than 1 and equal to or smaller than 30% by weight, and more preferably equal to or larger than 3 and equal to or smaller than 20% by weight. The compounding ratio of the flux activator compound in the resin layer 3 within the above-described range allows providing improved flux activity of the resin layer 3 and preventing a residue of the flux activator compound that is unreacted with the thermosetting resin in the resin layer 3.

Meanwhile, there are compounds serving as a curing agent for a thermosetting resin, which also has flux effect (hereinafter referred to as a flux activator curing agent for such compound). For example, a phenol novolac resin, a creosol novolac resin, an aliphatic dicarboxylic acid, an aromatic dicarboxylic acid and the like, which serve as curing agents for epoxy resin, also exhibit the flux effect. The resin layer 3 containing such flux activator curing agent, which acts as a flux activator compound and also acts as a curing agent for a thermosetting resin, serves as a resin layer having the flux effect.

In addition to above, the “flux activator compound having carboxyl group” indicates a compound having one or more carboxyl group(s) in its molecule, and may be in a form of liquid or in a form of solid. In addition, the “flux activator compound having phenolic hydroxyl group” indicates a compound having one or more phenolic hydroxyl group(s) in its molecule, and may be in a form of liquid or in a form of solid. In addition, the “flux activator compound having carboxyl group and phenolic hydroxyl group” indicates a compound having one or more carboxyl group(s) and one or more phenolic hydroxyl group(s) in its molecule, and may be in a form of liquid or in a form of solid.

Among these, the flux activator compounds having carboxylic group typically include an aliphatic acid anhydride, an alicyclic acid anhydride, an aromatic acid anhydride, an aliphatic carboxylic acid, and an aromatic carboxylic acid, and the like.

Aliphatic acid anhydrides serving as the flux activator compound having carboxylic group typically include succinic anhydride, poly adipic acid anhydride, poly azelaic acid anhydride, poly sebacic acid anhydride and the like.

Alicyclic acid anhydrides serving as the flux activator compound having carboxylic group typically include methyl tetrahydrophthalic anhydride, methyl hexahydrophthalic anhydride, anhydrous methyl humic acid, hexahydro phthalic anhydride, tetrahydro phthalic anhydride, trialkyl tetrahydrophthalic anhydride, methylcyclohexene dicarboxylic acid anhydride, and the like.

Aromatic acid anhydrides serving as the flux activator compound having carboxylic group typically include phthalic anhydride, trimellitic anhydride, pyromellitic dianhydride, benzophenone tetracarboxylic acid anhydride, ethylene glycol bistrimelitate, glycerol tristrimelitate, and the like.

Aliphatic carboxylic acid serving as the flux activator compound having carboxylic group typically include compounds shown by the following general formula (1), formic acid, acetic acid, propionic acid, butyric acid, valeric acid, pivalic acid, caproic acid, caprylic acid, lauric acid, myristic acid, palmitic acid, stearic acid, acrylic acid, methacrylic acid, crotonic acid, oleic acid, fumaric acid, maleic acid, oxalic acid, malonic acid, succinic acid, and the like.

HOOC—(CH₂)ₙ—COOH (1)

(in formula (1), n is an integer number of equal to or larger than 0 and equal to or lower than 20).

Aromatic carboxylic acid serving as the flux activator compound having carboxyl group typically include benzoic acid, phthalic acid, isophthalic acid, terephthalic acid, hemimellitic acid, trimellitic acid, trimesic acid, mellophanic acid, prehnitic acid, pyromellitic acid, mellitic acid, tolilic acid, xylic acid, hemellitic acid, mesitylenic acid, prehnitylic acid, toluic acid, cinnamic acid, salicylic acid, 2,3-dihydroxybenzoic acid, 2,4-dihydroxybenzoic acid, gentisic acid (2,5-dihydroxybenzoic acid), 2,6-dihydroxybenzoic acid, 3,5-dihydroxybenzoic acid, gallic acid (3,4,5-trihydroxybenzoic acid), naphthoic acid derivatives such as 1,4-dihydroxy-2-naphthoic acid, 3,5-dihydroxy-2-naphthoic acid and the like, phenolphthalin, diphenolic acid, and the like.

Among these flux activator compounds having carboxyl group, the compounds shown by the above general formula (1) are preferable, since these compounds provide well-balanced properties for the activity provided for the flux activator compound, quantity of outgas generated at the time of the cure of the resin layer, and the elastic modulus and the glass transition temperature of the cured resin layer, and the like. Among the compounds shown by the above general formula (1), the compounds with “n” in formula (1) of 3 to 10 are particularly preferable, since these compounds allow inhibiting an increase in the elastic modulus of the cured resin layer and providing improved adhesiveness between the circuit board 1 and the semiconductor element 2.

The compounds with “n” in formula (1) of 3 to 10 among the compounds shown by the above general formula (1) typically include, for example: glutaric acid (HOOC—(CH₂)₃—COOH) as n=3; adipic acid (HOCC—(CH₂)₄—COOH) as n=4; pimelic acid (HOOC—(CH₂)₅—COOH) as n=5; sebacic acid (HOOC—(CH₂)₈—COOH) as n=8; and HOOC—(CH₂)₁₀—COOH as n=10; and the like.

The flux activator compounds having phenolic hydroxyl group typically include phenols, and more specifically, for example, monomers having phenolic hydroxyl group such as phenol, o-creosol, 2,6-xylenol, p-creosol, m-creosol, o-ethylphenol, 2,4-xylenol, 2,5-xylenol, m-ethylphenol, 2,3-xylenol, mesitol, 3,5-xylenol, p-tertiary butylphenol, catechol, p-tertiary amylphenol, resorcinol, p-octylphenol, p-phenylphenol, bisphenol A, bisphenol F, bisphenol AF, biphenol, diallyl bisphenol F, diallyl bisphenol A, trisphenol, tetrakisphenol, and the like, phenolic novolac resins, o-reosol novolac resins, bisphenol F novolac resins, bisphenol A novolac resins, and the like.

The compounds having any of phenolic carboxylic group or hydroxyl group or the compounds having both of carboxylic group and phenolic hydroxyl group as described above react with the thermosetting resins such as epoxy resin to be three-dimensionally incorporated thereto.

Therefore, in view of providing improved creation of the three-dimensional network of polymer chains in the cured epoxy resin, the flux activator curing agents having the flux effect and serving as the curing agent for the epoxy resin is preferably employed for the flux activator compound. Typical examples of such types of the flux activator curing agents include, for example, compounds having two or more phenolic hydroxyl groups, which are capable of added to the epoxy resin, and one or more carboxyl group(s) directly bound to aromatic group exhibiting the flux effect (reduction effect) in one molecule. Such types of the flux activator curing agents typically include: benzoic acid derivatives such as 2,3-dihydroxybenzoic acid, 2,4-dihydroxybenzoic acid, gentisic acid (2,5-dihydroxybenzoic acid), 2,6-dihydroxybenzoic acid, 3,4-dihydroxybenzoic acid, gallic acid (3,4,5-trihydroxybenzoic acid) and the like; naphthoic acid derivatives such as 1,4-dihydroxy-2-naphthoic acid, 3,5-dihydroxy-2-naphthoic acid, 3,7-dihydroxy-2-naphthoic acid, and the like; phenolphthalin; and diphenolic acid and the like, and one of these compounds may be employed alone, or a combination of two or more of these compounds may be employed.

Among these, for the purpose of providing improved soldering between the first terminal 11 and the bump 21, it is particularly preferable to employ phenolphthalin. It is presumed that the use of phenolphthalin allows the cure of the epoxy resin after the oxide on the surface of the solder layer 112 is removed, which prevents the situation, in which the epoxy resin is cured while the oxide on the surface of the solder layer 112 remains unremoved, so as to present improved solder joint of the first terminal 11 and the bump 21.

In addition, the compounding ratio of the flux activity curing agent in the resin layer 3 may be preferably equal to or larger than 1 and equal to or smaller than 30% by weight, and more preferably equal to or larger than 3 and equal to or smaller than 20% by weight. The compounding ratio of the flux activity curing agent in the resin layer 3 within the above-described range allows providing improved flux activity of the resin layer and preventing a residue of the flux activity curing agent unreacted with the thermosetting resin in the resin layer.

In addition, the resin layer 3 may contain an inorganic filler.

The inclusion of the inorganic filler in the resin layer 3 achieves increased minimum melt viscosity of the resin layer 3 to prevent a creation of a gap between the first terminal 11 and the bump 21.

Typical inorganic fillers available here may include silica, alumina, and the like.

In addition, the resin layer 3 may contain a curing catalyst.

The curing catalyst may be appropriately selected depending on the type of the thermosetting resin in resin layer 3, and may typically include, for example, imidazole compounds may be employed in view of providing improved formability of the coated film. The imidazole compounds typically include 2-phenyl hydroxyimidazole, 2-phenyl-4-methylhydroxy imidazole and the like.

In addition, the compounding ratio of the curing catalyst may be, for example, equal to or higher than 0.01% by weight and equal to or lower than 5% by weight, when the sum total of all the constituents of the resin layer 3 is assumed to be 100% by weight. The compounding ratio of the curing catalyst of equal to or higher than 0.01% by weight achieves further effectively exhibiting the function as the curing catalyst to provide improved curing ability of the resin layer 3. The compounding ratio of the curing catalyst of equal to or lower than 5% by weight achieves further improved storage stability of the resin layer 3.

The methods for disposing the resin layer 3 between the circuit board 1 and the semiconductor chip 2 include, for example:

(1) a method, in which a resin film manufactured by forming a resin composition containing a flux activator compound into a film-form is prepared, and such resin film is laminated over the circuit board 1 or the semiconductor chip 2;
(2) a method, in which a liquid resin composition containing a flux activator compound is prepared, and such liquid resin composition is applied over the surface of the circuit board 1 or the semiconductor chip 2; and
(3) a method, in which a resin varnish containing a resin composition, which contains a flux activator compound dissolved or dispersed in a solvent, is prepared, and such resin varnish is applied over the surface of the circuit board 1 or the semiconductor chip 2, and then the solvent in the resin varnish is volatilized.

In addition to above, the liquid resin composition according to the above-described method (2) contains no solvent.

Here, as shown in FIG. 7, the plurality of resin layers 3 are arranged and coupled side by side to compose a single piece of a resin sheet extending over the plurality of circuit boards 1. More specifically, the resin sheet is composed of the plurality of resin layers 3 and coupling sections for coupling the respective resin layers 3, and the respective resin layers 3 are arranged and coupled side by side through the coupling sections.

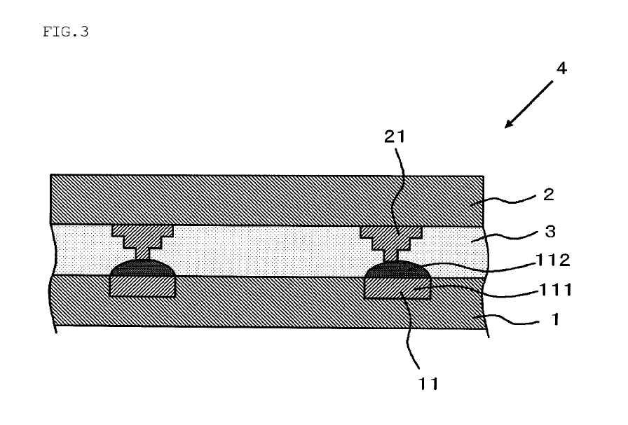

Next, the plurality of laminates 4 are compressively clamped along the direction of lamination of the laminates 4 so as to exert a load of 1 to 50 grams per one bump while heating the members so that the bump 21 are wedged into the resin layer 3 such that the first terminals 11 are in contact with the bumps 21 as shown in FIG. 3. In this occasion, the plurality of laminates 4 are heated so as not to initialize the cure of the resin layer 3. More specifically, the laminates 4 are heated, so that the minimum melt viscosity of the resin layer 3 of the laminate 4 is preferably equal to or higher than 0.1 Pa·s and equal to or lower than 10,000 Pa·s, and more preferably equal to or higher than 1 Pa·s and equal to or lower than 500 Pa·s. Heating in this manner allows ensuring the contacts between the first terminals 11 and the bumps 21.

In addition to above, the relation of the viscosity over the heating temperature can be determined as follows.

The melt viscosity can be measured under a condition of, for example, applying a shear of a frequency of 1 Hz at a temperature increase rate of 10 degrees/minute over a film-shaped sample specimen by employing a rheometer, which serves as a device for measuring a viscoelasticity.

In addition to above, the solder layer 112 of the first terminal 11 provides no solder joint of the first terminal 11 and the bump 21 in the present process step.

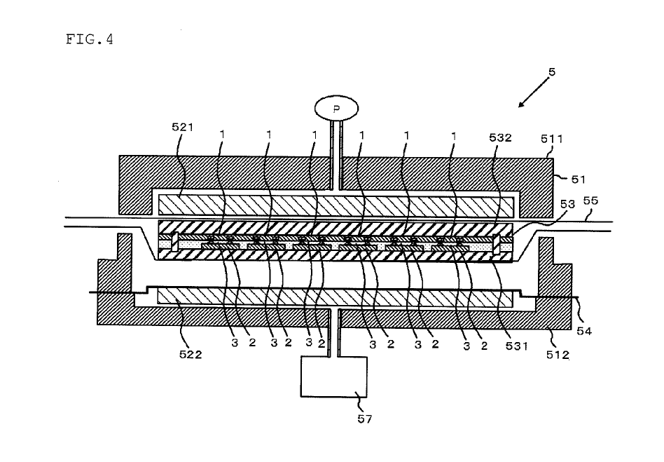

An apparatus 5 as shown in FIG. 4 to FIG. 6 is employed in the present process step.

The apparatus 5 is an equipment for conducting a process, in which the first terminals 11 are brought into contact with the bumps 21 after the resin layer 3 containing the flux activator compound and the thermosetting resin is disposed between the first terminals 11 of the circuit board 1, which includes the first terminals 11 having the solder layer 112 on the surface thereof, and the bumps 21 of the semiconductor chip 2, which includes the bumps 21 joined to the first terminal 11 of the circuit board 1, to form the laminates 4. Such apparatus 5 includes a compressive clamp member 53 for compressively clamping the plurality of laminates 4 all together, a diaphragm 54, a unit P of adjusting a pressure for achieving a vacuum condition in the inside of the heating furnace 51, and a unit 57 of supplying fluid for supplying a fluid in the inside of the heating furnace 51.

More specifically, the apparatus 5 includes an oven (heating furnace) 51, in which the plurality of laminates 4 are disposed, an upper hot plate 521 and a lower hot plate 522, both disposed in the oven 51, a jig 53 that is a compressive clamp member, the diaphragm 54, and a transfer section 55.

The oven 51 is composed of an upper mold 511 and a lower mold 512, and the upper hot plate 521 and the lower hot plate 522 are disposed in a cavity created by the upper mold 511 and the lower mold 512.

The upper hot plate 521 and the lower hot plate 522 are arranged to face to each other, and the jig 53 and the plurality of laminates 4 are disposed between the upper hot plate 521 and the lower hot plate 522. A pair of the hot plates 521 and 522 is at a temperature, which is lower than the melting point of the solder layer 112 and is lower than the curing temperature of the resin layer 3. Here, the curing temperature of the thermosetting resin means a temperature, at which the thermosetting resin is in the C-stage pursuant to the Japanese Industrial Standards (JIS) K6900.

The jig 53 includes flat members 531 and 532.

The plurality of laminates 4 are disposed between the member 531 and the member 532.

Each of the members 531 and 532 is in a form of a plate, and also in two-dimensional rectangular shape.

Here, the materials available for the member 532 and the member 531 are not particularly limited, and typically include a metallic plate, a ceramics plate and the like. The metallic plate typically includes, for example, a stainless steel plate, a titanium plate, and a lead plate. In addition, the ceramic plate typically includes a glass plate, an alumina plate, a silicon nitride plate and a zirconia plate. Among these, the type of the plate exhibiting better thermal conductivity is preferable.

The diaphragm 54 is disposed in the oven 51, and the circumference sections thereof (four sides thereof in the present embodiment, since the diaphragm 54 has two-dimensional rectangular geometry) are fixed to the lower mold 512. Such diaphragm 54 is configured of a film-formed elastic body, and for example, of a film made of a resin or a rubber. Such diaphragm 54 exhibits a flexibility.

The diaphragm 54 preferably has the hardness of equal to or higher than 10 and equal to or lower than 70, and also has a thickness of 0.5 to 6 mm.

The transfer section 55 serves as transferring the plurality of laminates 4 interposed by the member 531 and the member 532 of the jig 53 in the oven 51, and for example, is configured of a pair of transfer films.

Next, the method for using the apparatus 5 will be described.

In the beginning, the plurality of laminates 4 are disposed between the member 531 and the member 532 of the jig 53 as shown in FIG. 7 so that the plurality of laminates 4 are sandwiched with the member 531 and the member 532, which is carried out outside of the oven 51.

FIG. 7 is a schematic diagram, which illustrates a stage that the plurality of laminates 4 are sandwiched with the member 531 and the member 532.

Next, the jig 53 and the plurality of laminates 4 are placed on the transfer section 55, and the jig 53 and the plurality of laminates 4 are transferred to the inside of the oven 51 (see FIG. 4). In this stage, the upper hot plate 521 and the lower hot plate 522 are in the heated status in advance. Thereafter, the upper mold 511 is moved toward the lower mold 512, and the clearance between the upper mold 511 and the lower mold 512 is closed. This allows the upper hot plate 521 abutting against the member 531 of the jig 53.

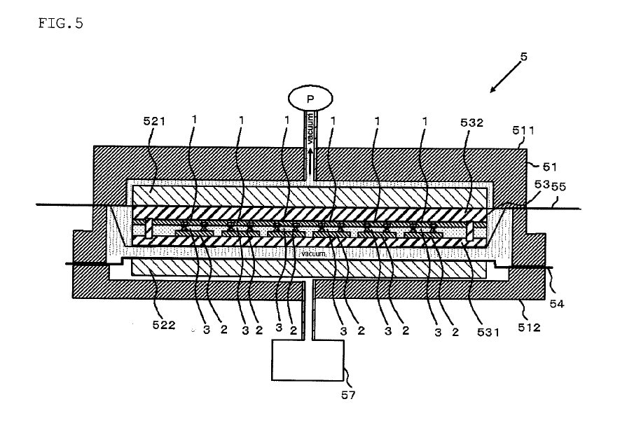

Next, a gas (air) in the oven 51 is suctioned by means of the unit P of adjusting the pressure that is connected to a suction port of the upper mold 511 to achieve a vacuum condition (equal to or lower than 500 hPa) in the interior of the oven 51. More specifically, the vacuum condition is achieved in the section surrounded by the upper mold 511 and the surface of the diaphragm 54 (see FIG. 5). In addition to above, it is sufficient to achieve the vacuum condition in the interior of the oven 51, and the lower limit of the atmospheric pressure is not particularly limited. However, in view of the structure of the oven 51, the vacuum pressure of equal to or higher than 0.1 hPa is preferable.

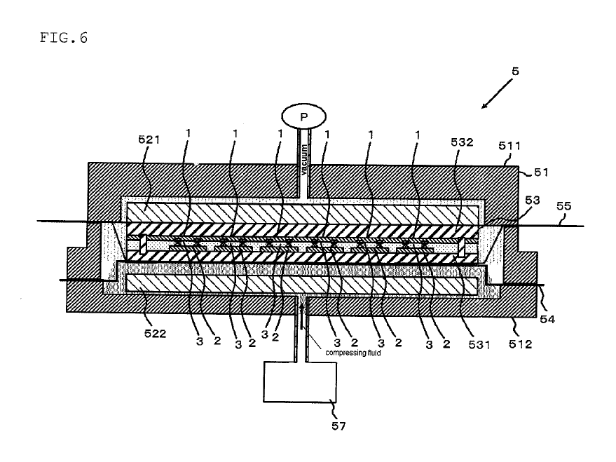

Thereafter, once the laminates 4 are heated to a predetermined temperature, a compression fluid is introduced in the oven 51 by means of the unit 57 of supplying fluid that is connected to the lower mold 512, while maintaining the vacuum condition by continuing the status for suctioning the gas from the inside of the oven 51, as shown in FIG. 6. In addition to above, a clearance is present between the bottom surface of the lower mold 512 and the lower hot plate 522, and the compression fluid is introduced into a space surrounded by the lower mold 512 and the diaphragm 54. The diaphragm 54 is pressed toward the upper direction from the side of the back surface by the compression fluid. The diaphragm 54, in turn, abuts against the member 531 of the jig 53 through a transfer film of the transfer section 55 to cause an elastic deformation along the surface feature of the member 531. The member 531 of the jig 53 is pressed toward the upper direction by the diaphragm 54, so that the jig 53 is compressively clamped with the hot plate 521 and the diaphragm 54. Then, the plurality of laminates 4 are to be compressively clamped by the members 531 and 532 of the jig 53. The plurality of laminates 4 are compressively clamped along the direction of lamination of laminate 4 under the vacuum condition, while heating laminates 4 at a temperature that is lower than the melting point of the solder layer 112 and lower than the curing temperature of the resin layer 3, and eventually the bumps 21 are wedged in the resin layer 3 so that the first terminals 11 are in contact with the bumps 21. A part of the resin layer 3 which is presented between the first terminals 11 and the bumps 21 is removed to cause the first terminals 11 to be contact with the bumps 21.

In addition to above, a gas is preferably employed for the compression fluid, and for example, preferable gas includes non-oxidation gas such as nitrogen gas, argon gas and the like, and air and the like.

Next, the compression with the compression fluid is stopped, and then The compression fluid is discharged from a compression fluid outlet port, which is not shown. Thereafter, the upper mold 511 is separated from the lower mold 512, and the plurality of laminates 4 are removed out from the interior of the oven 51.

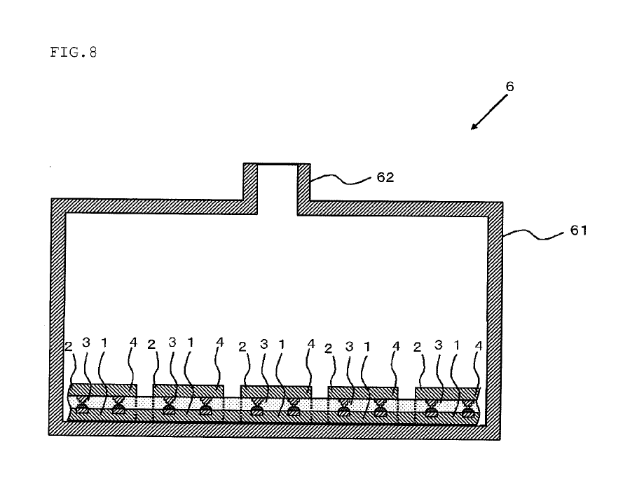

Then, the plurality of laminates 4 are heated to a temperature of equal to or higher than the melting point of the solder layer 112 of the first terminal 11 by employing an apparatus 6 shown in FIG. 8 to create solder joints of the first terminals 11 and the bumps 21.

The apparatus 6 is capable of heating the laminates 4 in a compressed atmosphere, and is constituted to have for example, a container 61 for housing the laminates 4 therein, and a duct 62 for introducing a fluid in such container 61.

The uniqueness of the container 61 is that the container is a pressure vessel, and after the laminates 4 are disposed in the container 61, the heated and further compressed fluid is flowed to the interior of the container 61 through the duct 62 to heat and compress the laminates 4.

Alternatively, a fluid may be flowed to the interior of the container 61 through the duct 62, and the container 61 may be heated under the compression atmosphere to eventually heat the laminates 4.

Material available for the container 61 typically includes metals and the like, and for example, stainless steel, titanium, and copper.

The pressure force for compressing the laminates 4 with the fluid is typically 0.1 to 10 MPa, and preferably 0.5 to 5 MPa. This allows inhibiting a generation of a gap (void) in the cured resin layer 3. Here, “compressing with a fluid” in the present invention means increasing the pressure of the atmosphere of the laminate 4 to be higher than atmospheric pressure by a value corresponding to the pressing force.

More specifically, “the compressing force of 10 MPa” means that the pressure exerted over the laminate is larger than the atmospheric pressure by 10 MPa.

After the laminates 4 are disposed in the container 61, the laminates 4 are heated and the laminates 4 are compressed.

The fluid for compressing the laminates 4 is introduced to the container 61 through the duct 62 to eventually compress the laminates 4. The preferable fluid for compressing the laminates 4 typically includes non-oxidation gas such as nitrogen gas, argon gas and the like, and air, and the like.

Among these, a non-oxidation gas is preferably employed. Here, the “non-oxidation gas” indicates an inert gas and nitrogen gas.

After the temperature of laminate 4 is reached to a point that is equal to or higher than the melting point of the solder layer 112, the laminates 4 are heated and compressed for the predetermined time duration while maintaining the temperature and the pressure in the container 61. This allows the cure of the resin layer 3 of the laminates 4.

Then, the laminates 4 are taken out from the apparatus 6, and when it is necessary, the cure of the laminates 4 may be repeated again.

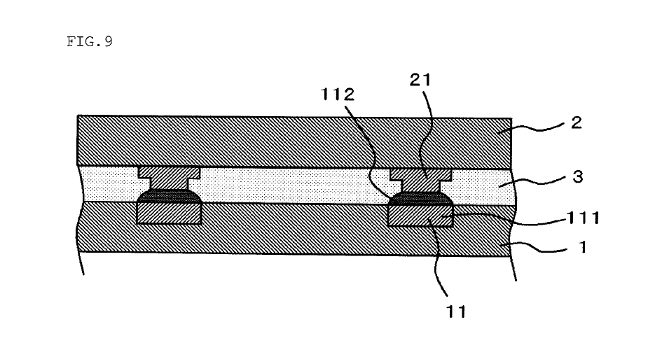

As described above, the electronic device can be obtained (see FIG. 9). FIG. 9 illustrates a condition, in which the bump 21 is joined to the first terminal 11 with the solder layer 112 and the top edge of the bump 21 is wedged into the solder layer 112. Further, the boundaries of the adjacent circuit boards 1 and the boundaries of the adjacent resin layers 3 are cut according to the cut lines of the dotted lines illustrated in FIG. 7 to obtain the plurality of separated electronic devices.

Next, advantageous effects of the present embodiment will be described.

The present embodiment involves that the plurality of laminates 4 are compressively clamped at the same time from the direction of lamination of the laminates 4, while the plurality of laminates 4 are heated.

This allows that, while the circuit board 1 of the first laminate 4 and the corresponding semiconductor chip 2 is compressively clamped, unwanted progress of the cure of the resin layers 3 in the other laminates 4 is prevented.

Therefore, the electronic devices with improved reliability can be stably produced.

In addition, the present embodiment also involves that the gas in the heating furnace 51 is suctioned and the plurality of laminates 4 are heated and compressed under the vacuum condition, so that air bubbles in the resin layer 3 of the laminate 4, air bubbles in the interface of the resin layer 3 and the semiconductor chip 2 and air bubbles in the interface of the resin layer 3 and the circuit board 1, can be removed. This allows creating stable coupling between the bump 21 of the semiconductor chip 2 and the first terminal 11 of the circuit board 1 to achieve enhanced connection reliability.

In addition to above, if the heating and the compression of the plurality of laminates 4 are not conducted under the vacuum condition, or more specifically if a number of the aforementioned air bubbles are present, these air bubbles may expand due to the heat in the process step of obtaining the laminates 4, which may lead to an adhesion of the resin of the resin layer 3 over the surface of the jig 53 for interleaving the laminates 4. This may cause a misalignment of the semiconductor chip 2 against the circuit board 1 when the laminates 4 are taken out from the jig 53, deteriorating the connection reliability. In addition, the expansion of the air bubbles may lead to a misalignment between the bump 21 of the semiconductor chip 2 and the first terminal 11 of the circuit board 1.

In addition, the present embodiment involves that the laminate 4 is compressed by employing the elastically deformable diaphragm 54. The diaphragm 54 is brought into the condition for abutting against the member 531 through the transfer film to cause an elastic deformation, resulting in achieving the compression of the laminates 4. Accordingly, the diaphragm 54 can be elastically deformed to be compressed along the surface of the member 531. For example, even if the surface of the member 531 includes an asperity, the diaphragm can be elastically deformed to follow along the surface of such member 531 to achieve the compression. In particular, since the diaphragm 54 has flexibility in the present embodiment, the elastic deformation and the compression of the diaphragm 54 can be achieved so as to firmly follow the asperity. While the diaphragm 54 is abutted against the member 531 through the transfer film in the present embodiment, the transfer film, which also exhibits flexibility, can also be deformed corresponding to the surface feature of the member 531. Further, even if, for example, the thickness of the member 531 is not uniform, the diaphragm 54 can also be elastically deformed and compressed so as to follow the surface of the member 531.

Therefore, a generation of a section that is subjected to an excessively larger pressure or a section that is subjected to an excessively smaller pressure or the like can be inhibited, as compared with the case of employing an elastically non-deformable pressing plate or the like. Therefore, it can be ensured to compress the respective laminates 4 to provide enhanced connection reliability of the bumps 21 of the semiconductor chip 2 with the first terminals 11 of the circuit board 1.

In addition, the present embodiment involves employing the jig 53 to compressively clamp the plurality of laminates 4. Therefore, a direct contact of the transfer film and/or the diaphragm 54 to the resin layer 3 is avoided when the laminates 4 are compressed, so that stains on the transfer film or the diaphragm 54 by the resin of the resin layer 3 can be prevented.

Further, since the present embodiment involves that the resin layer 3 is cured while compressing the laminates 4 by means of the compressing fluid, a creation of voids such as air bubbles or the like in the cured product of the resin layer 3 can be inhibited. Further, the compression of the laminates 4 with the fluid in the occasion for creating the solder joint of the first terminal 11 with the bump 21 provides increased density of the resin layer 3 to reduce the volume thereof, allowing an exertion of a force toward the direction for compressively contacting the first terminal 11 with the bump 21.

Further, the compression of the laminates 4 with the fluid in the occasion for creating the solder joint of the first terminal 11 with the bump 21 can inhibit the fluidization of the resin due to the creation of voids in the resin layer 3, ensuring the reduction of the misalignment between the first terminal 11 and the bump 21.

It is not intended that the present invention is limited to the above-mentioned embodiments, and any type of modification, improvement, and the like within the scope of achieving the objects of the present invention are included in the present invention.

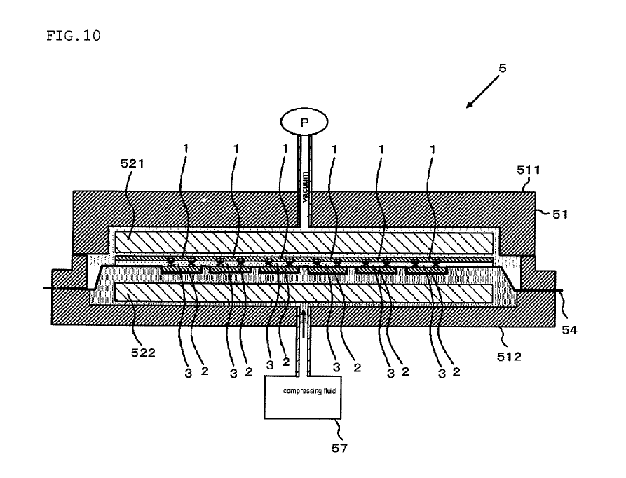

For example, while the jig 53 is employed in the apparatus 5 in the aforementioned embodiment, the configuration of the present invention is not limited thereto, and the jig 53 is not necessary to be employed as shown in FIG. 10.

In such case, the diaphragm 54 may be directly abutted to the plurality of laminates 4, so that the laminates 4 may be compressively clamped by the diaphragm 54 and the hot plate 521.

The diaphragm 54 comes into contact with the semiconductor chip 2 of the laminate 4 to elastically deform so as to follow the surface of the semiconductor chip 2, resulting in compressing the laminates 4 from the direction of the lamination. In such case, similarly as in the aforementioned embodiment, it can be ensured to compress the respective laminates 4.

Further, even if the semiconductor chips 2 having different thicknesses are employed, it is possible to compress the surface of the semiconductor chip 2 with the diaphragm 54, so that multiple types of semiconductor devices can be simultaneously produced.

Further, while the diaphragm 54 is fixed to the lower mold 512 in the aforementioned embodiment, the configuration of the present invention is not limited thereto, and the diaphragm 54 may alternatively be fixed to the upper mold 511, and a compressing fluid may be introduced from the side of the upper mold 511 to compress the laminates 4 with the diaphragm 54.

Further, while the circuit boards 1 or the resin layer 3 are arranged and coupled side by side in the aforementioned embodiment, the configuration of the present invention is not limited thereto. For example, the circuit boards 1 or the resin layers 3 may alternatively be isolated, and a clearance (gap) may be present between the circuit boards 1 or between the resin layers 3.

It is apparent that the present invention is not limited to the above embodiment, and may be modified and changed without departing from the scope and spirit of the invention.

What is claimed is:

1. A process for manufacturing a semiconductor device, said semiconductor device comprising a circuit board including a first terminal, which has a solder layer over its surface; and a semiconductor chip including a bump, which is joined to said first terminal of the circuit board,
said process comprising steps of:
obtaining a laminate by disposing a resin layer containing a flux activator compound and a thermosetting resin between the first terminal of said circuit board and the bump of said semiconductor chip; and
heating said laminate at a temperature that is equal to or higher than a melting point of said solder layer of said first terminal to create a solder joint of said first terminal with said bump, while compressing said laminate with a fluid, to cure said resin layer,
wherein, in said step of obtaining the laminate,
the first terminals of a plurality of said circuit boards are arranged to face the corresponding bumps of a plurality of said semiconductor chips,
said resin layer is disposed between the respective first terminals and the respective bumps to form a plurality of laminates, and
said plurality of laminates are simultaneously compressed from a direction of lamination of said laminate under a vacuum condition by causing an elastic deformation of a diaphragm disposed in a heating furnace while heating a plurality of said laminates in said heating furnace.

2. The process for manufacturing the semiconductor device according to claim 1,
wherein, in said step of obtaining the laminate,
a fluid is introduced in said heating furnace,
said diaphragm is pressed toward said laminate by said fluid, and
said plurality of laminates are simultaneously compressed from the direction of lamination of said laminate by the elastic deformation of said diaphragm.

3. The process for manufacturing the semiconductor device according to claim 2,
wherein a pair of compressive clamp members are disposed in the interior of said heating furnace and said diaphragm is disposed in the outside of at least one compressive clamp member of said pair of compressive clamp members, and
wherein after said plurality of laminates are disposed between said pair of compressive clamp members, said fluid is supplied into said heating furnace to press said diaphragm by said fluid, so that said diaphragm is abutted against said compressive clamp member to be elastically deformed and to press said compressive clamp member, such that said pair of compressive clamp members compress said laminates.

4. The process for manufacturing the semiconductor device according to claim 2,
wherein, in said step of obtaining the laminate, said plurality of laminates are simultaneously compressed from the direction of lamination of said laminate under the vacuum condition, so that the resin layers between the respective first terminals and the respective bumps are removed to cause the respective first terminals to be contact with the respective bumps.

5. The process for manufacturing the semiconductor device according to claim 3, wherein, said laminate is heated at a temperature that is lower than a curing temperature for said resin layer in said step of obtaining the laminate.

6. The process for manufacturing the semiconductor device according to claim 5, wherein, said laminates are heated, so that the minimum melt viscosity of said resin layer of said laminate is equal to or higher than 0.1 Pa·s and equal to or lower than 10,000 Pa·s in said step of obtaining the laminate.

7. An apparatus to contact a first terminal having a solder layer on a surface thereon in a circuit board and a bump of a semiconductor chip after depositing a resin layer containing a flux activator compound and a thermosetting resin is disposed between said first terminal of said circuit board and said bump of said semiconductor chip to form a laminate,
said apparatus comprising:
a heating furnace for heating a plurality of laminates;
a unit of creating a vacuum in said heating furnace; and
an elastically deformable diaphragm, disposed in the heating furnace and capable of simultaneously compressing said laminates from a direction of lamination of the plurality of laminates.

8. The apparatus according to claim 7, further comprising a supply unit of supplying a fluid in said heating furnace,
wherein said apparatus is configured that
said diaphragm is pressed toward said laminate by the fluid supplied by said supply unit to cause an elastic deformation of said diaphragm, so that said laminates are simultaneously compressed from the direction of lamination of said plurality of laminates.
